(19) United States
(12) Patent Application Publication
(10) Pub. No.: US 2026/0134569 A1
(43) Pub. Date: May 14, 2026

(54) METHOD FOR ACQUIRING GAZE POINT OF EYE AND TEST SYSTEM

(71) Applicant: LITE-ON TECHNOLOGY CORPORATION, TAIPEI CITY (TW)

(72) Inventors: HAO-YUAN KUO, TAIPEI CITY (TW); JYUN-YU SHIH, TAIPEI CITY (TW); Chih-Cheng Lin, TAIPEI CITY (TW)

(21) Appl. No.: 19/177,617

(22) Filed: Apr. 13, 2025

Related U.S. Application Data
(60) Provisional application No. 63/667,703, filed on Jul. 4, 2024.

(30) Foreign Application Priority Data
Dec. 25, 2024 (CN) 202411923789.8

(51) Int. Cl. G06T 7/73; G06F 3/01

(52) U.S. Cl. CPC G06T 7/73; G06F 3/013; G06T 2207/10048; G06T 2207/20081; G06T 2207/30201

(57) ABSTRACT

A method for acquiring a gaze point of an eye and a test system are provided. In the method operated in a computing device, position of a human face is frame-by-frame determined from continuous frames captured by a camera. Image features of the face are extracted for obtaining the positions of two eyes. A deep-learning model is operated to calculate confidences of multiple feature points of the eyes. One of the eyes is selected based on total confidences of the two eyes. User calibration is performed for eliminating an offset between the gaze point and a target point due to individual error. Therefore, a gazing direction is computed. The gazing direction and the feature points of the eye are referred to for identifying a central point of the eye and determining the gaze point, which is projected onto a display screen.

### CROSS-REFERENCE TO RELATED PATENT APPLICATION

This application claims the benefit of priority to China Patent Application No. 202411923789.8, filed on Dec. 25, 2024, in the People's Republic of China. The entire content of the above identified application is incorporated herein by reference.

This application claims the benefit of priority to the U.S. Provisional Patent Application Ser. No. 63/667,703, filed on Jul. 4, 2024, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for acquiring a gaze point of the eye, and more particularly to a method that can acquire the gaze point and a test system that uses a deep learning and various methods for eliminating the factors interfering with gaze point estimation so as to accurately acquire the gaze point and visualize the result.

### BACKGROUND OF THE DISCLOSURE

A conventional technology that directly estimates an eye gaze point by an intelligent model has been provided. However, the conventional technology is easily interfered by, for example, noises of a sensor, ambient lights and changes of a head posture of a user. If a result of the eye gaze point predicted by the model is directly projected onto a device, the above-mentioned interferences significantly reduce the accuracy of the prediction. Further, even if the user gazes at a fixed position, the above-mentioned interferences can still cause obvious jitter at the gaze point.

Still further, every person has his own kappa angle when the gaze point of the person is estimated. The kappa angle indicates a visual angle between a visual axis and a pupillary axis of the eye when the person gazes at an object. Inaccuracies among people due to the different kappa angles and various objective interference factors pose a challenge towards achieving a fast and stable gaze point input.

### SUMMARY OF THE DISCLOSURE

For accurately detecting a gaze point of an eye, the present disclosure provides a method for acquiring the gaze point of the eye that uses a deep-learning model and various ways that can reduce interferences when the gaze point is estimated, and a test system that operates the method.

The test system includes a computing device, in which a processor performs the method for acquiring the gaze point of the eye through collaboration with software. The test system includes a camera that is used to capture continuous frames. When the method for acquiring the gaze point of the eye is performed, the camera is used to capture the continuous frames, and a position of a face of a person can be frame-by-frame determined, and image features of the face can also be obtained for acquiring the positions of two eyes on the face.

Next, a deep-learning model is operated in the computing device for calculating a confidence with respect to each of the multiple feature points of each of the eyes. The confidences of the multiple feature points are summed to obtain a total confidence for each of the eyes. The total confidences of the two eyes are referred to for choosing one of the eyes used to calculate a gazing direction, which is the gazing direction of the chosen eye.

The test system further includes one or more display screens that are connected with the computing device. When the gazing direction of one of the eyes is obtained, a gaze point can be determined according to the gazing direction and a central point of the eye to be determined based on the feature points of the chosen eye. The gaze point is then projected onto the one of the one or more display screens.

In one of the embodiments, the gaze point to be projected onto one of the one or more display screens can be visualized. A gaze point stabilization process is performed for calculating an offset speed of the gaze point within a period of time, so that the gaze point can be stably projected onto one of the one of the one or more display screens.

Further, the gaze point stabilization process uses a weighted average method that introduces a speed threshold to obtain the gaze point with planar coordinates.

Further, before the gazing direction is calculated, a target point is projected onto one of the one or more display screens, and individual calibration is performed, so as to reduce individual error that is formed by an offset between the gaze point and the target point for compensating the offset of the position of the gaze point.

Further, one of the eyes is frame-by-frame chosen based on the total confidence of each of the two eyes; and the test system changes the chosen eye once the total confidence of the chosen eye is smaller than the total confidence of the other eye. When the total confidence of each of the eyes is calculated for choosing one of the eyes, the feature points of a head of the person are also referred to for estimating a roll angle, a yaw angle and a pitch angle of a head posture.

Still further, in the method for acquiring the gaze point of the eye, when the total confidence of each of the eyes is calculated for choosing one of the eyes, the multiple feature points of the two eyes are also referred to for determining a blinking status of the chosen eye and duration in the blinking status.

The test system can be used for testing an advanced driver-assistance system. When the advanced driver-assistance system is tested, the test system is used to obtain a gazing direction of the chosen eye and determine whether the gazing direction is directed toward an object that needs to be kept an eye on.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a framework of a test system that operates a method for acquiring a gaze point of an eye according to one embodiment of the present disclosure;

FIG. 2 is a schematic diagram depicting a gaze point of an eye to be obtained according to one embodiment of the present disclosure;

FIG. 3 is flowchart illustrating the method for acquiring the gaze point of the eye according to one embodiment of the present disclosure;

FIG. 4 is a schematic diagram illustrating facial feature points that are used in the method for acquiring the gaze point of the eye according to one embodiment of the present disclosure;

FIG. 5 is a schematic diagram illustrating feature points of an eye used in the method for acquiring the gaze point of the eye according to one embodiment of the present disclosure;

FIG. 6 is a schematic diagram illustrating a head posture to be obtained in the method for acquiring the gaze point of the eye according to one embodiment of the present disclosure; and

FIG. 7 is a schematic diagram illustrating an advanced driver-assistance system that applies the method for acquiring the gaze point of the eye in one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

For strengthening robustness and precision for eye-gaze point input, provided in the present disclosure is a method for acquiring a gaze point of an eye and a test system. The method is able to ensure smoothness and accuracy for an eye-tracking trajectory by filtering out or reducing interferences that affect stability and precision of the gaze point from various sources. For example, in certain embodiments, the confidences of the feature points of a head pose and a face of a person are referred to for dynamically choosing a most reliable eye that is configured to estimate the gaze point, by which the errors caused by occlusions or blinking of the eyes can be reduced. Further, the method for acquiring the gaze point of the eye also implements an individual calibration procedure that can be used to calibrate personalized influences such as the kappa angle of each of the eyes of the person. Accordingly, a personalized test system in compliance with an eye anatomy structure of the person is established.

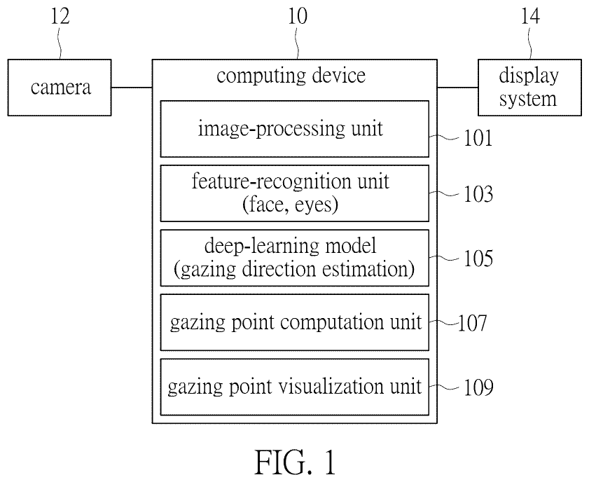

FIG. 1 is a schematic diagram illustrating a framework of the test system that operates the method for acquiring the gaze point of the eye according to one embodiment of the present disclosure.

The framework of the test system includes a computing device 10 that is implemented by a computer system through collaboration of hardware and software. A processor of the computer system performs the method for acquiring the gaze point of the eye. The computing device 10 includes an image-processing unit 101, a feature-recognition unit 103, a gaze point computation unit 107, and a gaze point visualization unit 109. The image-processing unit 101 is used to obtain an image of a person. The feature-recognition unit 103 is used to extract image features for recognizing a face and eyes of the person. The gaze point computation unit 107 is used to determine central points of the eyes and compute a position of a gaze point based on the features points of the eyes. The gaze point visualization unit 109 is used to visualize the gaze point and display the gaze point on a display screen.

Further, in the method performed by the test system for determining positions of the eyes and choosing one of the eyes for estimating the gaze point, a deep-learning algorithm is performed to learn facial image features of the person so as to establish a deep-learning model 105. The deep-learning model 105 is used to determine the positions of the two eyes, and calculate confidences of the two eyes. One of the eyes having a higher confidence is chosen for estimating the gaze point.

According to one embodiment of the present disclosure, the test system includes a camera 12. The camera 12 can be a near-infrared camera that is used to capture infrared images that will not be affected by ambient lights. Therefore, the infrared images can be effectively used to estimate the positions of the eyes. The camera 12 connects with the computing device 10 via a specific communication method or via a specific connection. The computing device 10 can generate signals to drive the camera 12 to capture images and to retrieve continuous frames. The continuous frames are processed by the processor that performs the method for acquiring the gaze point of the eye, in which the image-processing unit 101 is used to frame-by-frame determine the position of the face of the person, and the feature-recognition unit 103 is used to extract image features of the face, including the features of the positions of the two eyes.

In the meantime, the deep-learning model 105 implements an intelligence model that is used to choose one of the eyes to estimate the gaze point. In the present embodiment, the deep-learning model is used to calculate a confidence with respect to each of multiple feature points of the eyes. The confidences of the multiple feature points of each of the eyes are summed to obtain a total confidence. The total confidences of the two eyes are then referred to for choosing one of the eyes for estimating the gaze point. The gaze point computation unit 107 then computes a gazing direction of the chosen eye.

The test system additionally includes a display system 14 having one or more display screens. The one or more display screens are connected with the computing device 10. When the test system is in operation, a target point is projected onto one of the one or more display screens. The target point can be used to correct the gazing direction determined by the test system of the person. The gaze point computation unit 107 then obtains the gazing direction of the chosen eye and determines a central point of the chosen eye based on the feature points of the chosen eye. The central point of the chosen eye can be used to define an optical axis. The optical axis is referred to for determining the gaze point. Through a visualization process, the gaze point can be projected onto one of the one or more display screens of the display system 14 based on the central point of the chosen eye and the gazing direction.

Based on the above-described embodiment, the test system can accurately obtain the gaze point of the chosen eye by a deep learning method, stabilization of the gaze point and individual calibration, so that the gaze point can be displayed on the display screen by a visualization process and can be used in an input method of a human-computer interface.

According to one of the embodiments of the present disclosure, the test system can be used for testing an advanced driver-assistance system (ADAS), and the display system 14 can connect with the advanced driver-assistance system. When the advanced driver-assistance system is under test, the display system 14 is used to project a target point onto a display screen, and the camera 12 can be used to capture images of a user of the advanced driver-assistance system. The positions of the two eyes of the user can be obtained and used to calculate a gazing direction of one of the eyes. The display screen of the display system 14 then displays a gaze point. In the meantime, the target point can be used to calibrate individual error. The test system can accordingly determine whether or not the gazing direction is directed toward an object that needs to be kept an eye on, and the object can be a vehicle, a pedestrian or any object rushing into the road that driver should pay attention to in an image of a front road.

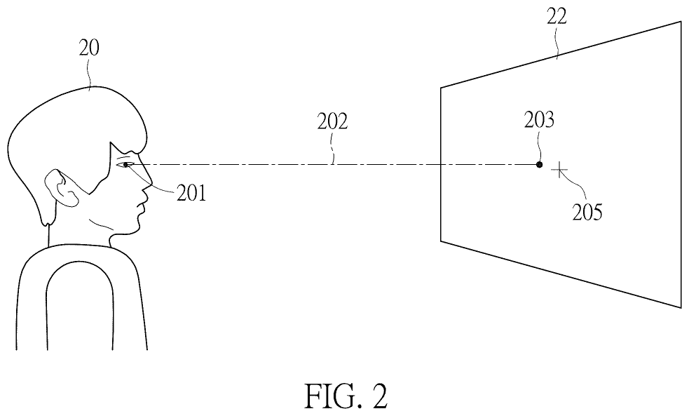

Reference is made to FIG. 2, which is a schematic diagram depicting an example of a gaze point of eye. A user 20 in front of a display screen 22 is shown in the diagram. A camera module (not shown in the diagram) disposed in the display screen 22 is used to capture images of the user 20. The position of an eye 201 of the user 20 can be determined based on image features of the images. As mentioned above, a confidence of each of the feature points of the eyes can be calculated, and is referred to for choosing the eye 201. A gazing direction 202 of the eye 201 can be estimated, a central point of the eye 201 can be determined, and an optical axis of the eye 201 can be defined so as to determine a gaze point 203 of the eye 201. The display screen 22 then displays the gaze point 203 through visualization.

It should be noted that individual error for each person may be generated when the test system calculates the gaze point 203. The individual error may be formed due to a combination of several factors such as the kappa angle and an alignment degree of a center line of various display screens and a central axis of a face of the user 20. In the methods for acquiring gaze point of eye and performing calibration, the test system is used to display a target point 205 on the display screen 22 for calibration. The test system allows the user 20 to gaze on the target point 205 and determines the gaze point 203 through the algorithm. After that, an offset between the target point 205 and the gaze point 203 can be measured and used to perform individual calibration for reducing the individual error caused by the offset.

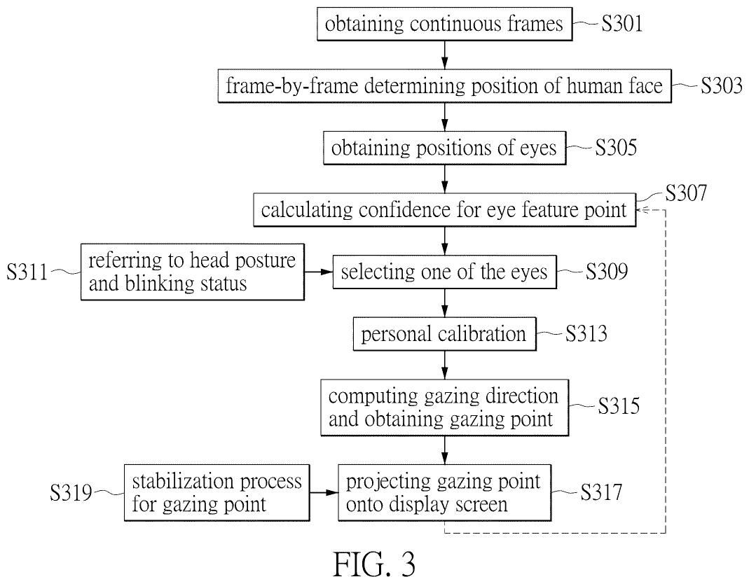

Reference is next made to FIG. 3, which is a flowchart illustrating the method for acquiring the gaze point of an eye according to one embodiment of the present disclosure.

In the beginning, a camera is used to capture continuous frames in real time (step S301). Image features can be frame-by-frame extracted through an image processing process so as to determine a position of a face (step S303). The facial image features are extracted for obtaining positions of two eyes (step S305).

In one embodiment of the present disclosure, the camera can be a near-infrared camera. One of the reasons of selection of the near-infrared camera is that, when the user's face is illuminated by an infrared light, contrast between a pupil and a surrounding iris of one of the eyes can be increased since the pupil can reflect more infrared light than the surrounding iris. Therefore, pupil visibility of the pupil can be strengthened by the infrared light, and the position and size of the pupil can be accurately detected and tracked for increasing accuracy in determining the gaze point of an eye. One further reason of using the near-infrared camera is that the infrared image is not easily affected by changes in ambient light and is useful under a low-light environment with complex lighting. Still further, the infrared image can still improve the accuracy of determining positions of two eyes even if the user wears glasses or contact lenses. Accordingly, the test system can apply the infrared image that is more stable than a visible light. Thus, the near-infrared camera allows the test system to provide the more stable and more reliable continuous infrared frame images, and the stability of eye tracking can be improved. Furthermore, the infrared light used in the test system will not cause the user to feel eye fatigue during a long-term eye tracking process, since the near-infrared light is invisible and not glaring to the human eyes.

The above-mentioned solution for improving the stability and accuracy in determining the positions of the eyes can be combined with the features of strengthening pupil visibility of pupil, stability of the infrared image, and eliminating the problems of eye fatigue due to long-term eye tracking so as to effectively improve the accuracy when determining the gaze point of the eye. Therefore, an eye-input method can be applied to more critical technologies such as the advanced driver-assistance system used in the vehicle.

When the image features are extracted, the eye features (e.g., the features such as a central point of the pupil and positions of eye corners) can be used to obtain positions of the user's face and two eyes, including positions and sizes of the pupils, the eyelids and a head pose.

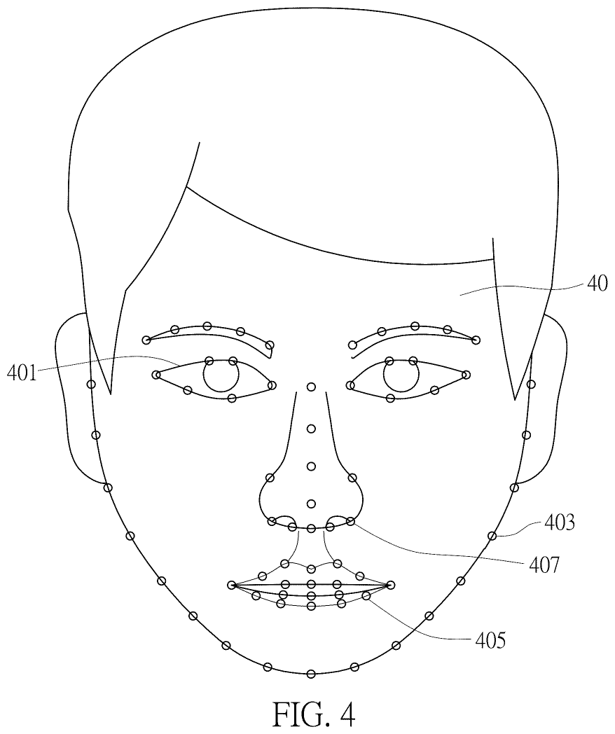

The embodiment for extracting feature points of the face can be referred to in FIG. 4, which is a schematic diagram illustrating the facial feature points used in the method for acquiring gaze point of an eye. An image of a human face 40 obtained through photographing is shown in the diagram. A deep-learning model firstly decides a facial box and determines positions of facial organs according to the facial image features. The facial image features can be marked as a landmark so as to establish multiple facial feature points 401, 403, 405 and 407 that are used to depict the human face 40.

The above-mentioned facial feature points (i.e., the landmark) may include the features such as eyes, ears, a mouth, eyebrows, a nose tip and a jaw that can be used to recognize the human face. The diagram exemplarily shows two eye outlines that are depicted by multiple feature points 401, a facial box that is depicted by multiple feature points 403, a mouth that is depicted by multiple feature points 405 and a nose that is depicted by multiple feature points 407.

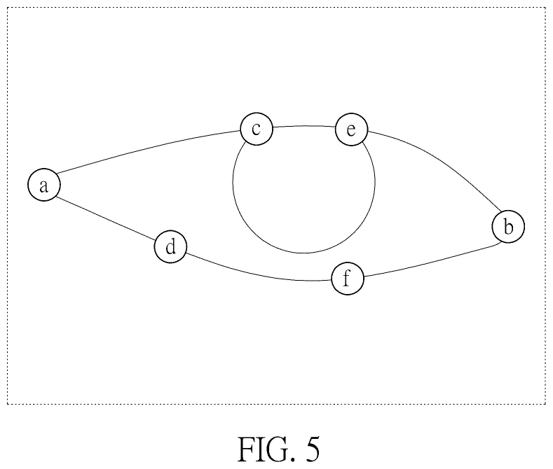

Reference is also made to FIG. 5, which is a schematic diagram illustrating the feature points of one of the eyes used in the method for acquiring the gaze point of an eye according to one embodiment of the present disclosure. Multiple feature points a, b, c, d, e and f used to depict the eye are shown in detail. A confidence of each of the feature points can be calculated. The confidence can be used to indicate an accuracy of determining that the feature point is part of an eye. The probability of determining that the feature point is part of an eye is higher if the confidence is higher. Therefore, the eye with the highest confidences is chosen to be the eye used to determine the gaze point. In the example, multiple feature points (e.g., six feature points shown in the diagram) surrounding the eye are shown in the diagram. The confidences with respect to the feature points a, b, c, d, e and f are summed to obtain a total confidence of one of the eyes. The total confidence may be dynamically changed with variations of the eye or the head. Therefore, the test system may dynamically choose one of the eyes used to calculate the gazing direction.

When the facial feature points 401, 403, 405 and 407 and the feature points a, b, c, d, e and f of the eye are obtained, a deep-learning model is used to calculate the confidences for each of the feature points a, b, c, d, e and f of the eye. The confidences for the feature points are then summed to obtain the total confidence of each of the eyes (step S307), and one of the objectives is to allow the test system to choose the eye with the highest confidence based on the confidences of the multiple feature points (step S309).

In step S309, the one of the eyes is frame-by-frame chosen based on the total confidence of each of the two eyes; and the test system changes the chosen eye once the total confidence of the chosen eye is smaller than the total confidence of the other eye. After that, the gazing direction and the gaze point projected onto one of the one or more display screens are calculated in response to choosing the one of the eyes (step S315).

In the step S309 of calculating the total confidence of each of the eyes so as to choose the one of the eyes, in one of the embodiments, the head pose and a status of eye-blinking are also referred to for dynamically choosing the eye with a higher confidence (step S311). Specifically, the head pose can be determined according to the features extracted from the continuous frames in real time, such as a rotating face based on the facial feature points 401, 403, 405 and 407, positions of the two eyes and/or changes of the multiple feature points a, b, c, d, e and f that are used to depict the eyes.

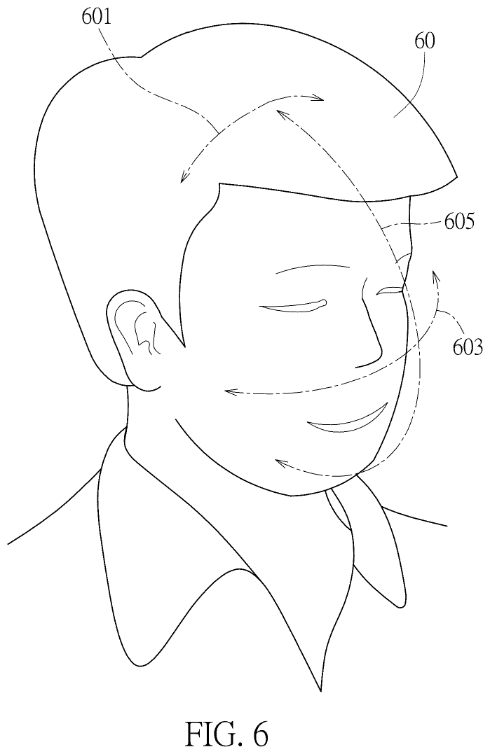

Reference is made to FIG. 6, which is a schematic diagram depicting the head pose obtained in the method for acquiring gaze point of eye according to one embodiment of the present disclosure.

FIG. 6 schematically shows several angular changes of a user's head 60 relative to various photographing directions. For the arrows shown in the diagram, a roll angle 601 indicates a movement of tilting the head 60 left and right; a yaw angle 603 indicates a movement of shaking the head 60 left and right; and a pitch angle 605 indicates a movement of nodding the head 60 up and down. The roll angle 601, the yaw angle 603 and the pitch angle 605 form an Euler angle that describes a rotating posture of the head 60 in a 3D (three-dimensional) coordinate system.

Further, in the method for acquiring gaze point of eye, the yaw angle 603 can be used to estimate which eye of the user is looking at a camera or a display screen, and choose the eye that is used to estimate the gazing direction (step S309).

An algorithm of using the head pose to choose the eye for estimating the gazing direction can be referred to in Equation 1. In an example, the direction of a person's head toward the camera is set to 0 degrees, and it is determined that the head pose is turning right and the right eye of the person is gradually covered when the yaw angle 603 (i.e., “yaw” in Equation 1) of the head pose is larger than or equal to 30 degrees. Accordingly, the left eye of the person is chosen to be the eye (“eye” in Equation 1) for estimating the gazing direction. Otherwise, it is determined that the head pose is turning left and the left eye of the person is gradually covered when yaw angle 603 of the head pose is smaller than or equal to −30 degree, and the right eye of the person is chosen.

$$eye = \{ \begin{matrix}left eye , & if yaw \geq 30 degrees , \\ right eye , & if yaw \leq - 30 degrees\end{matrix} . \qquad Equation 1$$

Next, the multiple feature points a, b, c, d, e and f are defined on an outline of each of the eyes. The coordinates of these feature points a, b, c, d, e and f can be used to calculate a distance between upper and lower eyelids and a distance between left and right eye corners of each of the eyes. Therefore, a ratio of these two distances can be calculated, and the ratio is used to determine a blinking status of the chosen eye.

One further example can be referred to in Equation 2 that incorporates coordinate positions of the feature points a, b, c, d, e and f of the eye shown in FIG. 5. The relative positions among the feature points a, b, c, d, e and f of the eye are referred to for calculating an eye lid ratio between the upper eyelid and the lower eyelid. The eye lid ratio in each of the frames can be assigned with a score. A ratio threshold set by the system can be used to determine whether the eye is kept closed or just blinking temporarily.

Determination of the blinking status is, but not limited to, as shown in Equation 3, by which it is determined that the eye is blinking when a duration of the eye closing is less than or equal to 0.25 seconds, and otherwise it is determined that the eye is closed if the duration is more than 0.25 seconds. In the present embodiment, it is determined that the eye is blinking temporarily when the score of the eye lid ratio of the chosen eye is smaller than the ratio threshold and the duration is less than and equal to 0.25 seconds (T_{close}), and it is not necessary for the test system to change the eye to be used to estimate the gaze point. On the contrary, if the score of the eye lid ratio of the chosen eye is still smaller than the ratio threshold, but the duration is more than 0.25 seconds (T_{close}), it is determined that the eye is closed, and the test system determines to change the eye to be used to estimate the gaze point. Thus, when one of the eyes is chosen in step S309, the determination of head pose and detection of the blinking status (step S311) can be referred to for accurately choosing the eye that can be used to calculate the gazing direction and the gaze point more effectively.

$$Eye Lid Ratio = \frac{‖ c - d ‖ + ‖ e - f ‖}{2 * ‖ a - b ‖} . \qquad Equation 2$$

$$Blink = {T}_{close} \leq 0.25 seconds . \qquad Equation 3$$

Moreover, in the method for acquiring the gaze point of an eye, individual calibration is performed beforehand for eliminating an offset between the gaze point and a target point due to individual error before the gazing direction is performed. Therefore, the offset of the gaze point can be compensated (step S313), and the gazing direction and the gaze point can be obtained more precisely (step S315).

Next, the computing device of the test system can rely on the offset to perform individual calibration so as to eliminate differences of an angle and the offset between an actual gaze point of the user and the target point set by the system. Therefore, the gaze point of the user can accurately fall on the target point set by the test system.

According to the embodiment of the present disclosure, in the step S313 of FIG. 3 of performing individual calibration, the test system including one or more display screens allows a user to gaze on a specific point displayed on one of the display screens. The specific point is such as the target point 205 of FIG. 2. The test system calculates a gaze point (e.g., the gaze point 203 of FIG. 2) of the user by the above-described algorithm, and compares the coordinates of the gaze point 203 with the coordinates of the target point 205 for obtaining the error there-between. As described above, the error is formed by combining various factors including a kappa angle and an alignment degree between a center line of each of display screens and a central axis of a face of the user.

In the step S315 of determining the gaze point that is projected onto the display screen beyond a certain distance along the gazing direction, in one embodiment of the present disclosure, the test system establishes a 3D coordinate system with a center of a camera as an origin. The gazing direction of the eye that is estimated based on positions of the eye and pupil in the 3D coordinate system can be displayed on one of the one or more display screens with a well-known resolution through a visualization process (step S317).

It should be noted that, in the visualization process, for strengthening clearness of the gaze point, a gradient circle representation method is performed for gradually increasing color transparency of the circular gaze point from a central region toward the circular outer edge. The central region of the circular gaze point can be kept opaque so as to enhance the clearness of the gaze point.

The above flow can be continuously operated and the step S307 to step S317 are repeatedly performed on the continuous frames.

In one further embodiment of the present disclosure, in a process of visualizing the gaze point of the eye, a gaze point stabilization process is performed (step S319). From a technical perspective, movements of the human eyes can be classified into three types of eye movements: fixations, saccades and smooth pursuit. The fixation movement indicates a stable state where the eyes are focusing on a point, the saccades movement indicates that the eyes are changing their gaze point rapidly and jerkily so as to scan surroundings, and the smooth pursuit movement indicates that the eyes are slowly tracking a moving object so as to ensure that the object is moving within a sight. It is possible that the above-mentioned eye movements are co-existing for operating visual perception, attention and interaction with environment. Therefore, in the gaze point stabilization process, when the test system projects the gaze point onto one of the one or more display screens, an offset speed of the gaze point within a period of time can be calculated based on the several above-mentioned types of eye movements, and, based on the offset speed, an offset compensation operation can be performed to resolve the impacts of such as jitters and noise to the gaze point. Therefore, the gaze point can be stably projected onto one of the one or more display screens.

In one of the embodiments of the present disclosure, the gaze point stabilization process uses a velocity-based threshold combined with weighted average method to obtain a gaze point Gₚ with planar coordinates xᵢ and yᵢ, as shown in Equation 4. In Equation 4, “i” indicates a number of a frame, “n” is a total number of frames, and “wᵢ” indicates a weight value of each of the frames. The “n” continuous frames form a weight distribution. The weight values can be used to reduce excessive changes of the position of the gaze point so as to avoid unexpected changes or jitters of the gaze point. The coordinates xᵢ and yᵢ of each of the continuous frames “1” to “n” are respectively multiplied by the weights “wᵢ”, and the products are summed and then divided by a total number of the weight values “wᵢ” of all of the frames. The gaze point Gₚ can be therefore obtained. A scaling factor “∝” is introduced for calculating an offset speed “vᵢ” of the gaze point within a period of time “Δt”. Thus, the gaze point stabilization process is able to compensate the position of the gaze point based on the offset speed of the gaze point. Therefore, the gaze point can be stably displayed.

$${G}_{p} = \frac{( {\sum }_{i}^{n} {x}_{i} * {w}_{i} , {\sum }_{i}^{n} {y}_{i} * {w}_{i} )}{{\sum }_{i}^{n} {w}_{i}} ; \qquad Equation 4$$

$${w}_{i} = \frac{1}{1 + ∝ * {v}_{i}} ;$$

$${v}_{i} = sqrt ( {( \frac{{x}_{i} - {x}_{i - 1}}{Δ t} )}^{2} + {( \frac{{y}_{i} - {y}_{i - 1}}{Δ t} )}^{2} ) .$$

Thus, the method for acquiring gaze point of eye of the present disclosure can be used to overcome the above-described various interferences to estimation of the gaze point, and the errors caused by the individual errors and head movement of different persons. A stable, fast and accurate input method based on the gaze point of eye can be finally provided for human-machine interaction.

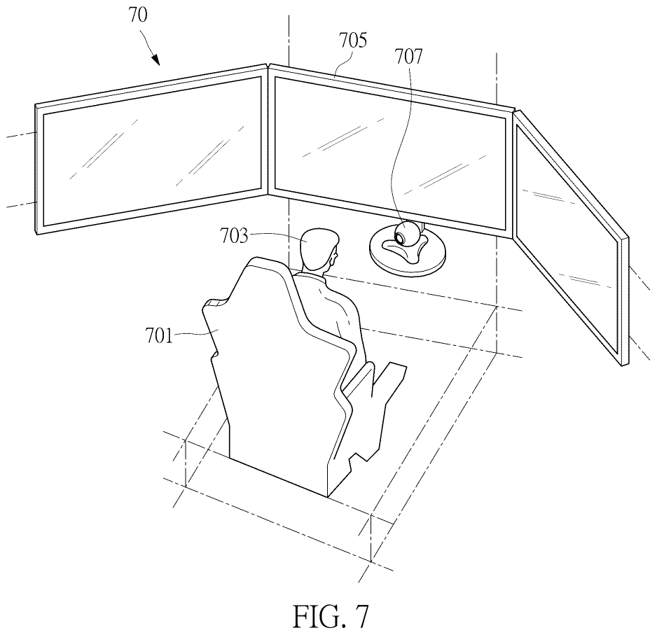

In certain applications using the gaze point of eye to be an input method, the user is allowed to use the gaze point displayed on the display screen to conduct interaction. Reference is made to FIG. 7, which is a schematic diagram illustrating the method for acquiring gaze point of eye being applied to an advanced driver-assistance system (ADAS) according to one embodiment of the present disclosure.

The provided test system can be used in the advanced driver-assistance system. In one embodiment of the present disclosure, a simulator cabin 70 for the advanced driver-assistance system is provided. The simulator cabin 70 includes multiple display screens that are configured to generate a virtual semi-panoramic image. With a position of a seat 701 of the advanced driver-assistance system, the virtual semi-panoramic image covers a 180-degree field of view of a driver 703. A camera 707 that can be an occupant monitoring system (OMS) camera is also provided.

The advanced driver-assistance system includes a computing device (not shown in the diagram) that operates the method for acquiring gaze point of eye. The advanced driver-assistance system uses the camera 707 to capture images of the driver 703 who is seated on the seat 701 in real time. The images particularly cover the positions of the head, face and eyes of the driver 703. The computing device is used to calculate the gazing direction of one of the eyes and the gaze point that is configured to be projected onto one of the display screens of a display system 705.

When the advanced driver-assistance system is under test, the gaze point can be used for an input method, and provided for a user in the advanced driver-assistance system to interact with. The user can use a chosen eye to obtain the gaze point, and the gaze point is used to determine the gazing direction. The test system then determines whether the gazing direction is directed toward an object that needs to be kept an eye on. For example, when the gaze point is determined to be within a bounding box of an object in the images, the color of the bounding box can be changed. An interaction test is achieved.

It should be noted that, when the display system 705 includes multiple display screens, since positions and angles covering fields of view of the display screens are different, it is necessary for the user to perform individual calibration between the user and each of the display screens in an initialization process. The display system 705 should apply different compensation parameters for different users in order to calibrate the error between the gaze point of the user and the target point set by the system. Taking the three display screens shown in FIG. 7 as an example, the angle of field of view of a central screen covers −30 degrees to +30 degrees. A set of offset compensation values with individual calibration are applied to any display screen within the above-mentioned angle of field of view. The display screens disposed on two sides of the display system 705 correspond to the angle covering 30 degrees to 90 degrees of field of view and require the corresponding offset compensation values.

In conclusion, according to the above embodiments of the present disclosure, the method for acquiring gaze point of eye and the test system operating the method and the advanced driver-assistance system to be implemented by the test system are provided. In the method for acquiring gaze point of eye, a deep learning approach, stabilization of gaze point and individual calibration are provided for eliminating factors that interfere with acquiring the gaze point of eye so as to strengthen stability and accuracy of the gaze point of eye. Furthermore, the status of the eyes of the user (e.g., head-turning and eye-blinking) can be referred to for dynamically determining the eye used to determine the gaze point. Therefore, the gaze point of the eye can be stably, quickly, and accurately applied to an input method for a human-machine interface.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A test system, comprising:
a computing device; and
a camera connected with the computing device and used to capture an image for retrieving continuous frames;
wherein the computing device uses a processor to perform a method for acquiring the gaze point of an eye, comprising:
retrieving continuous frames captured by the camera;
frame-by-frame determining a position of a face of a person;
obtaining image features of the face for obtaining positions of two eyes on the face;
calculating a confidence on each of multiple feature points that illustrate each of the eyes, and obtaining a total confidence of each of the eyes;
choosing one of the eyes as a chosen eye used to calculate a gazing direction based on the total confidence of each of the eyes; and
calculating the gazing direction using the chosen eye.

2. The test system according to claim 1, wherein a deep-learning model is operated in the computing device for calculating the confidence of each of the multiple feature points of each of the eyes and a total confidence that is a summation of multiple confidences of the multiple feature points.

3. The test system according to claim 1, wherein the test system also includes one or more display screens that connect with the computing device; when the gazing direction of the chosen eye is obtained, a gaze point is determined according to the gazing direction and a central point of the chosen eye that is determined based on the multiple feature points, and the gaze point is projected onto one of the one or more display screens.

4. The test system according to claim 3, wherein, when the gaze point is projected onto the one of the one or more display screens, a gaze point stabilization process is performed to calculate an offset speed of the gaze point within a period of time, so that the gaze point is stably projected onto the one of the one or more display screens.

5. The test system according to claim 4, wherein the gaze point stabilization process uses a weighted average method that introduces a speed threshold to obtain the gaze point Gₚ with planar coordinates xᵢ and yᵢ by equation:
$${G}_{p} = \frac{( {\sum }_{i}^{n} {x}_{i} * {w}_{i} , {\sum }_{i}^{n} {y}_{i} * {w}_{i} )}{{\sum }_{i}^{n} {w}_{i}} ;$$
$${w}_{i} = \frac{1}{1 + ∝ * {v}_{i}} ;$$
$${v}_{i} = sqrt ( {( \frac{{x}_{i} - {x}_{i - 1}}{Δ t} )}^{2} + {( \frac{{y}_{i} - {y}_{i - 1}}{Δ t} )}^{2} ) ;$$
in which, “i” is a number of each of the frames, “n” is a total number of the frames, “wᵢ” is a weight value for each of the frames, “∝” is a scaling factor, and the offset speed “vᵢ” of the gaze point within a period of time.

6. The test system according to claim 3, wherein, before the gazing direction is calculated, a target point is projected onto one of the one or more display screens and individual calibration is performed, so as to reduce individual error that is formed by an offset between the gaze point and the target point for compensating the offset of position of the gaze point.

7. The test system according to claim 1, wherein, one of the eyes is frame-by-frame chosen based on the total confidence of each of the two eyes; and the test system changes the chosen eye once the total confidence of the chosen eye is smaller than the total confidence of the other eye.

8. The test system according to claim 7, wherein, in the method for acquiring the gaze point of the eye, when the total confidence of each of the eyes is calculated for choosing one of the eyes, the feature points of a head of the person are also referred to for estimating a roll angle, a yaw angle and a pitch angle of a head posture.

9. The test system according to claim 8, wherein, given that a direction of the head of the person toward the camera is a zero-degree angle, a left eye is chosen when the yaw angle of the head posture is greater than 30 degrees in a rightward direction, and a right eye is chosen when the yaw angle of the head posture is greater than 30 degrees in a leftward direction.

10. The test system according to claim 7, wherein, in the method for acquiring the gaze point of the eye, when the total confidence of each of the eyes is calculated for choosing one of the eyes, the multiple feature points of two eyes of the person are also referred to for determining a blinking status of the chosen eye and a duration of the blinking status.

11. The test system according to claim 10, wherein the multiple feature points are defined on an outline of each of the eyes, and the blinking status of the chosen eye is determined by calculating a ratio of a distance between upper and lower eyelids and a distance between left and right eye corners based on coordinates of the multiple feature points.

12. The test system according to claim 1, wherein the camera is a near-infrared camera.

13. The test system according to claim 1, wherein the test system is used in an advanced driver-assistance system; and, when the advanced driver-assistance system is tested, the test system obtains the gazing direction of the chosen eye and determines whether the gazing direction is directed toward an object that needs to be kept an eye on.

14. A method for acquiring a gaze point of an eye, operated in a test system, and comprising:
retrieving continuous frames;
frame-by-frame determining a position of a face;
obtaining image features of the face for obtaining positions of two eyes on the face;
calculating a confidence on each of multiple feature points that illustrate each of the eyes, and obtaining a total confidence of each of the eyes;
choosing one of the eyes as a chosen eye used to calculate the gaze point based on the total confidence of each of the eyes; and
calculating the gaze point to be projected onto one of one or more display screens using the chosen eye.

15. The method according to claim 14, wherein the confidence of each of the multiple feature points of each of the eyes is calculated, and a total confidence is obtained by summing multiple confidences of the multiple feature points.

16. The method according to claim 14, wherein, when a gazing direction of the chosen eye is obtained, the gaze point is determined according to the gazing direction and a central point of the chosen eye that is determined based on the multiple feature points, and the gaze point is projected onto the one of the one or more display screens.

17. The method according to claim 16, wherein, when the gaze point is projected onto the one of the one or more display screens, a gaze point stabilization process is performed to calculate an offset speed of the gaze point within a period of time, so that the gaze point is stably projected onto the one of the one or more display screens.

18. The method according to claim 17, wherein the gaze point stabilization process uses a weighted average method that introduces a speed threshold to obtain the gaze point Gₚ with planar coordinates xᵢ and yᵢ by equation:
$${G}_{p} = \frac{( {\sum }_{i}^{n} {x}_{i} * {w}_{i} , {\sum }_{i}^{n} {y}_{i} * {w}_{i} )}{{\sum }_{i}^{n} {w}_{i}} ;$$
$${w}_{i} = \frac{1}{1 + ∝ * {v}_{i}} ;$$
$${v}_{i} = sqrt ( {( \frac{{x}_{i} - {x}_{i - 1}}{Δ t} )}^{2} + {( \frac{{y}_{i} - {y}_{i - 1}}{Δ t} )}^{2} ) ;$$
in which, “i” is a number of each of the frames, “n” is a total number of the frames, “wᵢ” is a weight value for each of the frames, “∝” is a scaling factor, and the offset speed “vᵢ” of the gaze point within a period of time.

19. The method according to claim 16, wherein, before the gazing direction is calculated, a target point is projected onto the one of the one or more display screens and individual calibration is performed, so as to reduce an individual error that is formed by an offset between the gaze point and the target point for compensating the offset of position of the gaze point.

20. The method according to claim 14, wherein, one of the eyes is frame-by-frame chosen based on the total confidence of each of the two eyes; and the test system changes the chosen eye once the total confidence of the chosen eye is smaller than the total confidence of the other eye.

21. The method according to claim 20, wherein, when the total confidence of each of the eyes is calculated for choosing one of the eyes, the feature points of a head are also referred to for estimating a roll angle, a yaw angle and a pitch angle of a head posture.

22. The method according to claim 21, wherein, given that a direction of the head toward the camera is a zero-degree angle, a left eye is chosen when the yaw angle of the head posture is greater than 30 degrees in a rightward direction, and a right eye is chosen when the yaw angle of the head posture is greater than 30 degrees in a leftward direction.

23. The method according to claim 20, wherein, when the total confidence of each of the eyes is calculated for choosing one of the eyes, multiple feature points of two eyes of the person are also referred to for determining a blinking status of the chosen eye and a duration of the blinking status.

24. The method according to claim 23, wherein the multiple feature points are defined on an outline of each of the eyes, and the blinking status of the chosen eye is determined by calculating a ratio of a distance between upper and lower eyelids and a distance between left and right eye corners based on coordinates of the multiple feature points.
